(19) United States
(12) Patent Application Publication
(10) Pub. No.: US 2013/0035959 A1
(43) Pub. Date: Feb. 7, 2013

(54) METHODS AND SYSTEMS FOR TRACKING MEDICAL CARE

(71) Applicants: Kristen CLICKNER, Virginia Beach, VA (US); Scott WILLIAMSON, Virginia Beach, VA (US); Lynn SWANNER, Virginia Beach, VA (US)

(72) Inventors: Kristen CLICKNER, Virginia Beach, VA (US); Scott WILLIAMSON, Virginia Beach, VA (US); Lynn SWANNER, Virginia Beach, VA (US)

(73) Assignee: SENTARA HEALTHCARE, Norfolk, VA (US)

(21) Appl. No.: 13/572,235

(22) Filed: Aug. 10, 2012

Related U.S. Application Data
(63) Continuation-in-part of application No. 12/499,010, filed on Jul. 7, 2009.

(51) Int. Cl. G06Q 50/24

(52) U.S. Cl. 705/3

(57) ABSTRACT

Methods and systems for tracking medical care are described. In an example embodiment, a method for ambulatory care tracking, comprises entering a chief complaint into an electronic file in a computing system, assigning a chief complaint point value based on the chief complaint, associating the chief complaint point value to the electronic file in the computing system, determining a further point value based on patient education, assigning the further point value based on the determination, adding, using a processor, the further point value to the chief complaint point value to generate a total point value, determining, using a processor, a level of service based on the total point value, and communicating, over an electromagnetic communication channel, the level of service to a billing system.

### PRIORITY

This application claims priority as a continuation-in-part to U.S. patent application Ser. No. 12/499,010, filed Jul. 7, 2009, which is hereby incorporated by reference in its entirety for any purpose.

### FIELD

This application relates to methods and systems for tracking medical care, for example, physician practice care and for determining a level of service at the ambulatory practice level and communicating the level of service to a main hospital system.

### BACKGROUND

Ambulatory practice medical care can be a fast-paced environment in which it is time consuming to enter billing codes into computer systems. As a result, some billing may be missed or entered incorrectly.

### SUMMARY

This summary is provided to introduce a selection of concepts in a simplified form that are further described below in the Detailed Description. This summary is not intended to identify key features or essential features of the claimed subject matter, nor is it intended to be used as an aid in determining the scope of the claimed subject matter.

In an example, a computerized method, and system for tracking medical care, can include entering a chief complaint into an electronic file in a computing system, assigning a chief complaint point value based on the chief complaint, associating the chief complaint point value to the electronic file in the computing system, determining a further point value based on additional treatment, assigning the further point value based on the determination, adding, using a processor, the further point value to the chief complaint point value to generate a total point value, determining, using a processor, a level of service based on the total point value, and communicating, over an electromagnetic communication channel, the level of service to a billing system.

In an example, entering the chief complaint includes opening an ambulatory practice electronic record in an ambulatory practice computing system and opening a main patient record in a hospital computing system. In an example, determining the level of service includes setting a critical care flag in the ambulatory practice record. In an example, determining the level of service includes determining a critical care level of service based on the total point value being at least a critical care point value. In an example, determining the critical care level of service includes requesting a confirmation of adequate documentation for the critical care level of service. In an example, determining the critical care level of service triggers special processing according to predetermined procedures. In an example, the predetermined procedures are mandated by a government.

In further examples, the above methods steps are stored on a machine-readable medium comprising instructions, which when implemented by one or more processors perform the steps. In yet further examples, subsystems or devices can be adapted to perform the recited steps. Other features, examples, and embodiments are described below.

### BRIEF DESCRIPTION OF DRAWINGS

Embodiments are illustrated by way of example and not limitation in the figures of the accompanying drawings, in which like references indicate similar elements and in which:

FIG. 1 is a schematic diagram of a system according to an example embodiment;

FIG. 2 is a schematic diagram of a system according to an example embodiment;

FIG. 3 is a schematic diagram of a system according to an example embodiment;

FIG. 4 is a flow chart of a method according to an example embodiment;

FIGS. 5A-B are flow charts of a method according to an example embodiment;

FIG. 6 is a flow chart of a method according to an example embodiment;

FIG. 7 is a is a flow chart of a method according to an example embodiment;

FIG. 8 is a user interface according to an example embodiment;

FIGS. 9A-B are user interfaces according to an example embodiment;

FIG. 9C is an user interface according to an example embodiment and

FIG. 10 is a schematic view of a computing subsystem according to an example embodiment.

### DETAILED DESCRIPTION

Example methods and systems for tracking medical care are described. In the following description, for purposes of explanation, numerous specific details are set forth in order to provide a thorough understanding of example embodiments. It will be evident, however, to one skilled in the art that the present invention may be practiced without these specific details.

In some example embodiments, methods and systems for tracking medical care can enable a medical care provider, such as a hospital, clinic or doctor office or other medical care provider, to assign weighted values to services rendered in care for a patient. The weighted values can be combined according to predetermined criteria and, based on the resulting value, a level of service required by the patient can be determined. The level of service can be provided to the billing department. Various examples described herein can be used for care for an ambulatory patient.

An example method for tracking medical care may commence with receiving a chief complaint. The chief complaint can be communicated by the patient upon being admitted to a medical care facility. If the patient is unable to communicate the chief complaint, the chief complaint can be communicated by a party facilitating the patient's admission to the medical care facility. Another way that the chief complaint can be entered when the patient is unable to communicate is via deduction based on the apparent condition of the patient. The chief complaint can be updated when more information regarding the patient's condition becomes available. Entering a chief complaint is not necessary when the patient's condition is not severe. For example, in case of an influenza, there can be multiple complaints (e.g., a sore throat, a fever, a stuffy nose, and a headache) none of which are severe.

If a chief complaint is entered, it can be associated with a typical resource category indicating the acuity of the complaint. The typical resource category can be, in turn, associated with a base weight point value. The base weight point value represents the minimum amount of resources required to care for a patient with a particular chief complaint, and includes standard minimum services provided for that chief complaint.

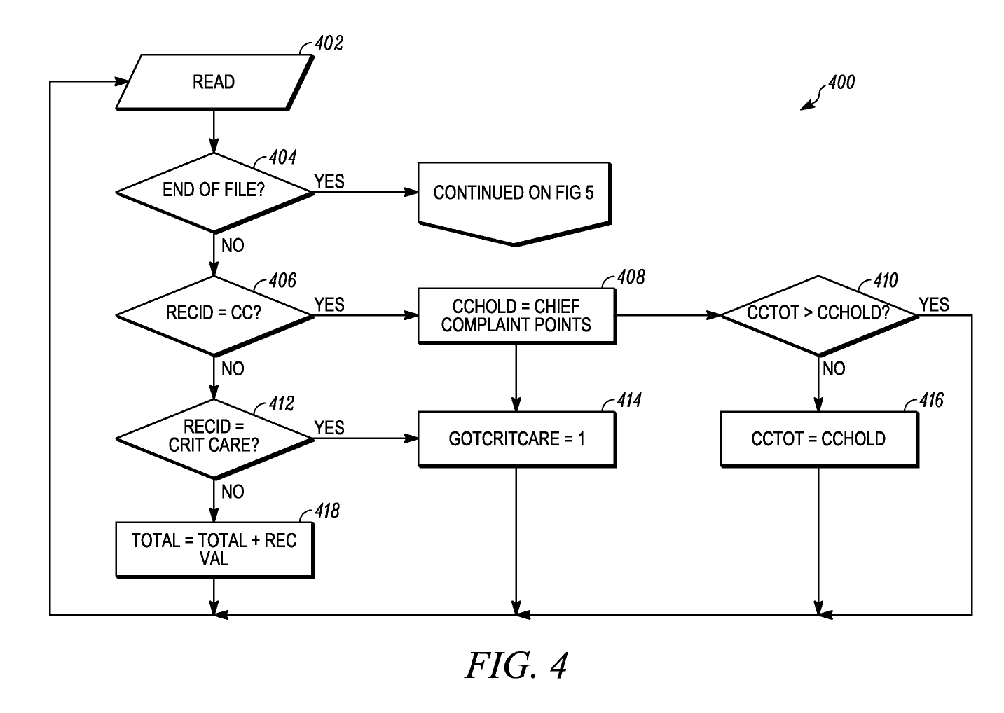

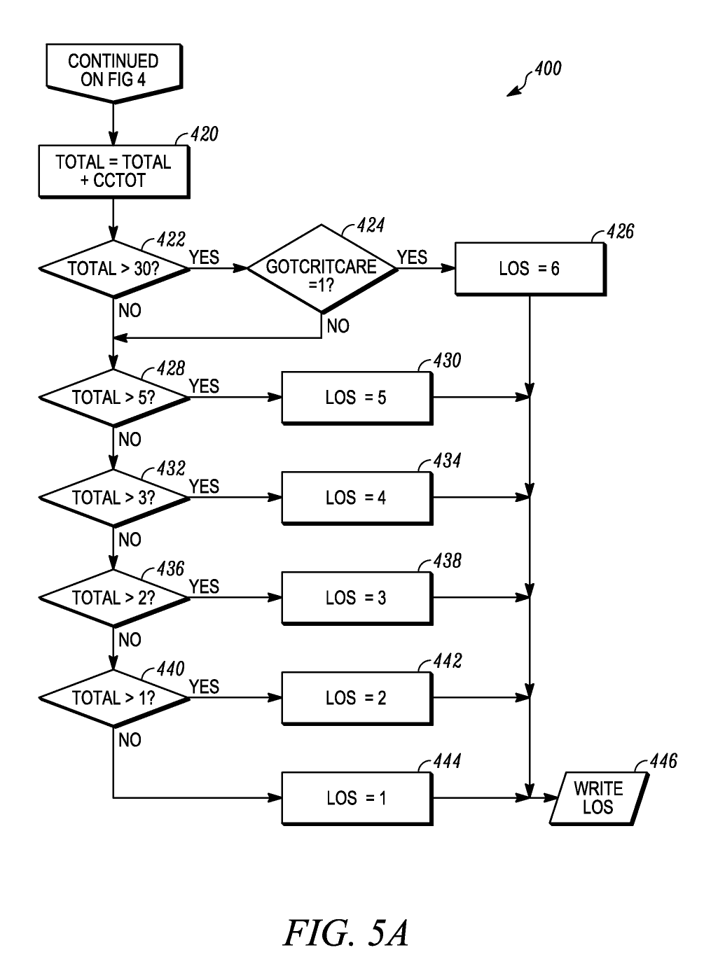

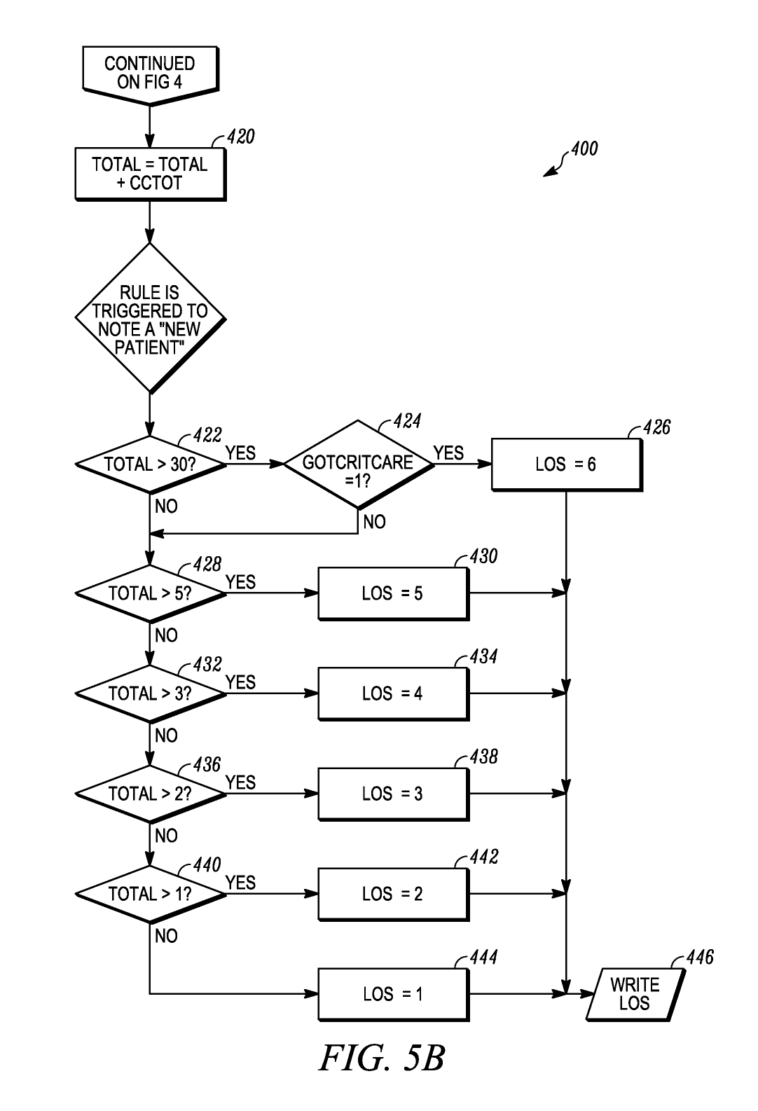

Whether or not a chief complaint is entered, each service can be associated with certain point values. These point values can be added to the total point value as the service is documented. When a chief complaint is entered, besides the base weight point value, additional services can be required to care for the patient, e.g., an ambulatory patient. Accordingly, additional points can be added to the base weight point value. Based on the total number of points, a level of service can be calculated. Example calculation of the total number of points described below with reference to FIGS. 4 and 5.

The total number of points being greater than a predetermined threshold can be indicative of the critical care level of service. However, when no chief complaint is entered, the patient cannot be classified as a critical care patient. When the patient is classified as a critical care patient, special procedures are to be performed as mandated and specified by the government. Thus, the methods and systems for tracking medical care can enables accounting of the resources required to care for a patient and complying with government regulations.

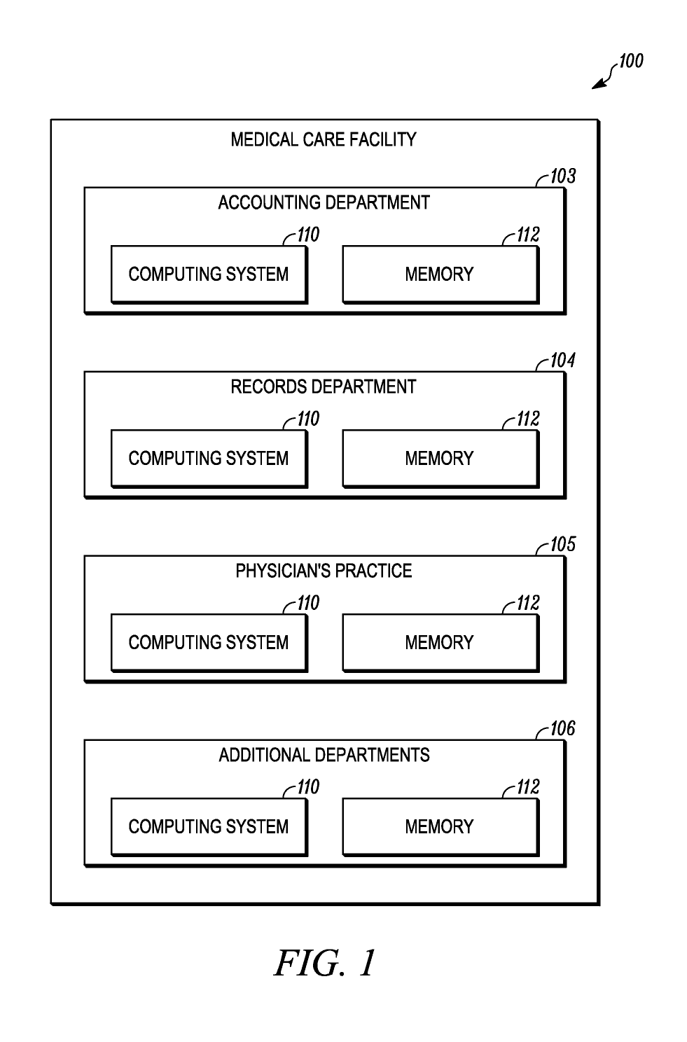

FIG. 1 illustrates an example system 100 of a medical care facility, and more specifically, a hospital. The medical care system 100 includes various departments such as an accounting department 103, a records department 104, a physician's practice, such as an ambulatory practice 105, and additional departments 106. Departments 103-109 include a computing system 110 and a memory 112, which can operate to store data relating to that department, rules that are applied to the data, rules that request input, and other rules as needed by a particular department. The business rules can be stored on the machine-readable media in the memory 112. The computing systems 110 apply the rules to the data to create results that can also be stored in the memory 112. The computing systems 110 cam communicate with each other over communication channels to transfer data between the various departments in the medical care system.

The accounting department 103 is a department of the medical care facility 100 to which charges associated with the resources required to care for a patient can be forwarded. The accounting department 103 can process the charges and bill the responsible party accordingly. In general, the accounting department 103 can be utilized to process, verify, and report the value of assets, liabilities, income, and expenses in the books of account to which debit and credit entries are posted.

The records department 104 can be utilized to process and store records such as meeting minutes, memorandums, employment contracts, patient information records, and documents related to the accounting department 103. The records stored by the records department 104 can be retrievable to enable the review of the records as required. The physician's practice, such as an ambulatory practice 105 is a medical care facility that provides initial treatment to patients with a broad spectrum of illnesses and injuries, some of which may be life-threatening and requiring immediate attention. The ambulatory practice 105 enables rapid assessment and management of critical illnesses. Upon arrival to the ambulatory practice 105, a patient can undergo a triage, or sorting interview, to help determine the nature and severity of the illness. Based on this triage, a chief complaint can be documented in the patient's records kept and stored in the records department 104.

A patient with a serious chief complaint can be seen by a physician more rapidly. After initial assessment and treatment, a patient can be admitted to the hospital, stabilized and transferred to another hospital for various reasons, or discharged. The personnel facilitating services received by a patient in the ambulatory practice 104 can include not only doctors and nurses, but also other professionals with specialized training in emergency medicine such as paramedics, emergency medical technicians, respiratory therapists, radiology technologists, volunteers, and other. The fast-paced environment of the ambulatory practice 105 can make it difficult to record and assign weight value to the resources required to care for a patient. The chief complaint can remain a primary fact until the attending physician eventually makes a diagnosis.

The computing system 110 can be utilized to execute lists of instructions stored at the memory 112. The memory 112 can refer to computer components, devices, and recording media that retain digital data used for computing for some interval of time. The memory 112 can refer to a form of semiconductor storage known as random access memory (RAM) and sometimes other forms of fast, but temporary storage. Additionally, the memory 112 can refer to mass storage such as optical discs, forms of magnetic storage like hard disks, and other storage of a more permanent nature.

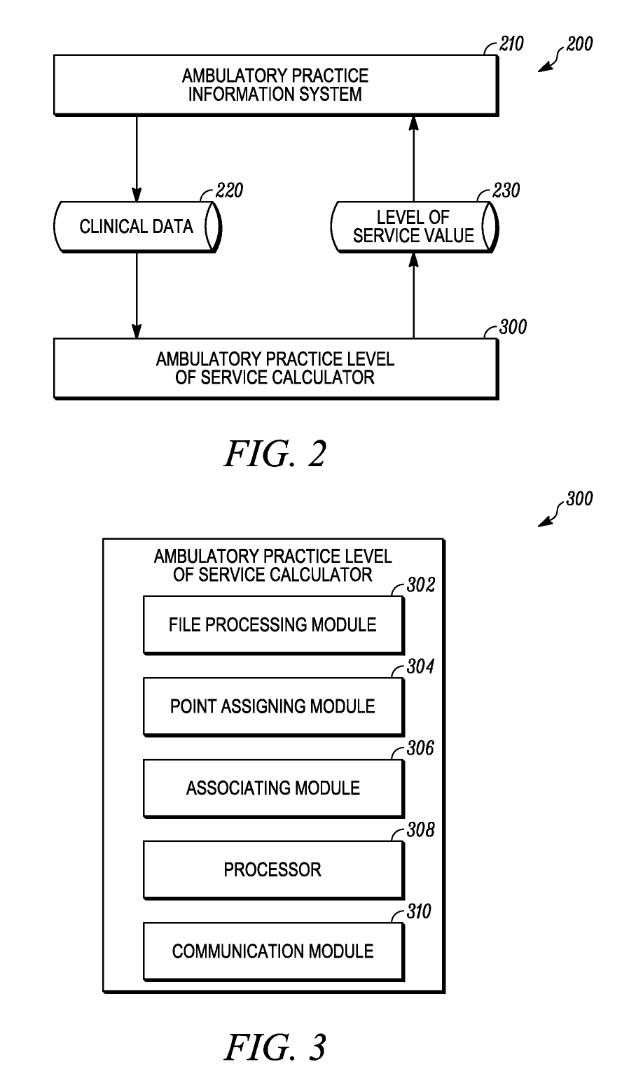

FIG. 2 illustrates an example system 200 of the ambulatory practice 105. The system 200 can include an ambulatory practice information system 210, clinical data 220, a level of service value 230, and an ambulatory practice level of service calculator 300. The ambulatory practice information system 210 can process an Electronic Health Record (EHR) of a patient being admitted to the ambulatory practice 105. The EHR can refer to an individual patient's medical record in digital format. The ambulatory practice information system 210 can co-ordinate the storage and retrieval of individual records from the records department 104 over a network. The EHR may be made up of electronic medical records (EMRs) from many locations and/or sources. Among the many forms of data included in EMRs are patient demographics, medical history, medicine and allergy lists (including immunization status), laboratory test results, radiology images, billing records, and advanced directives.

The ambulatory practice information system 210 can enable the ambulatory practice personnel to create, store, and access medical records. As shown in FIG. 2, the ambulatory practice information system 210 can create the clinical data 220 relating to a patient. The clinical data 220 can include a chief complaint, services associated with the chief complaint, as well as any additional resources required to care for the patient.

The clinical data 220 can be received by the ambulatory practice level of service calculator 300, which will assign a point value to the services included in the clinical data 220. Based on the point value, the ambulatory practice level of service calculator 300 can determine the level of service 230, which can be sent back to the ambulatory practice information system 210.

The level of service 230 can be important in a medical emergency when the injury or illness is acute and poses an immediate risk to a patient's life or long term health. Dependent on the severity of the emergency, and the quality of any treatment given, it may require the involvement of multiple levels of care, from a first aider to an emergency physician through to specialist surgeons. Any response to an emergency medical situation depends on the situation. The ambulatory practice 105 can follow certain procedures based on the condition of the patient. In some example embodiments, procedures can be mandated by the state and/or federal government. These procedures can require numerous resources. Based on the resources involved the ambulatory practice level of service calculator 300 calculates the level of service required. An example ambulatory practice level of service calculator 300 is described in more detail by way of example with reference to FIG. 3.

FIG. 3 illustrates the example ambulatory practice level of service calculator 300. The ambulatory practice level of service calculator 300 can include a file processing module 302, a point assigning module 304, an associating module 306, a processor 308, and a communication module 310. Example operations of these modules are described in more detail with reference to methods illustrated in FIGS. 4, 5, and 6.

FIG. 4 illustrates a flow chart of a method 400 for tracking medical care. The method 400 can commence at 402 with the file processing module 302 reading a file including a list of resources associated with patient. The file can be supplied by the ambulatory practice information system 210 in the clinical data 220 and received by the communication module 310. The file processing module 402 can read the file line by line. Upon reading each successive line, the file processing module 302 can determine, at decision block 404 whether or not the end of the file is reached. If the file processing module 302 determines that the end of the file is reached, the method 400 proceeds to operation 420 illustrated on FIG. 5. If, on the other hand, the end of the file is not reached, the method 400 proceeds to decision block 406. At decision block 406, the file processing module 302 can determine whether or not the record ID variable is assigned the chief complaint (RECID=CC).

If the record ID is assigned a chief complaint, the point assigning module 304 can assign a chief complaint hold variable a value of the chief complaint points associated with the chief complaint (CCHOLD=CHIEF COMPLAINT POINTS) at operation 408. Thereafter, the method 400 can proceed to decision block 410, in which the processor 308 can determine whether or not the total number of chief complaint points is greater than the chief complaint hold value (CCTOT>CCHOLD). Because the chief complaint is associated with the ambulatory practice 103, the patient can be classified as a critical care patient and at operation 414, the associating module 306 can associate the patient record with the critical care (GOTCRITCARE=1).

If, at decision block 410, it is determined that the total number of chief complaint points is greater than the chief complaint hold value, the method can proceed to operation 402 and read another line of the file. Otherwise, the value of the total chief complaint points can be incremented to the chief complaint hold value before proceeding to operation 402.

Returning back to decision block 406, if it is determined that no chief complaint is associated with the record ID, the method 400 can proceed to decision block 412 in which the file processing module 302 can determine whether or not the record ID indicates that the patient requires critical care (RECID=CRIT CARE). If it is determined that the patient requires critical care, the associating module 306 can associate the patient record with the critical care (GOTCRITCARE=1) at operation 414 and proceed to operation 402 in which the file processing module 302 can read another line of the file. If on the other hand, the file processing module determines at operation 412 that the patient does not requires critical care, the method 400 can proceed to operation 418, in which the processor 310 can increment the total number of points associated with the patient record by the points derived from the current record (TOTAL=TOTAL+RECVAL). The method 400 can continue iterating through the logical loops described herein until it is determined at decision block 404 that the end of file is reached.

FIGS. 5A-B illustrate the second part of the example method 400 (FIG. 5A for an established patient and FIG. 5B for a new patient, respectively). In FIGS. 5A-B, the method 400 can proceed to operation 420 in which the total points are added to the total chief points (TOTAL=TOTAL+CCTOT) 420 to produce the total number of points. If the patient is new, a rule is optionally triggered which can then adjust the calculation (e.g., for levels 1-5). At operation 422, the processor 308 can determine whether or not a certain predetermined threshold value is reached. Reaching the predetermined threshold value can indicate that the patient can be classified as a critical care patient. Thus, the total number of points can be compared to the set threshold value (e.g., 30 points). The set threshold value can be predetermined by reimbursement policies of a payor, e.g., governmental entity, insurance company, or patient group. If it is determined that the total number is greater than the threshold value, the method 400 can proceed to decision block 424. Once at decision block 424 it can be determined whether the critical care value is set to one. If the critical care value is not set to one, the patient is not to be classified as critical care patient despite reaching the threshold value of points. If, on the other hand, the critical care value is set to one, the method can proceed to operation 426, in which the associating module 306 can set the level of service to a predetermined high value indicating that the patient is in need of critical care (e.g., LOS=6).

If the patient is not a critical care patient, the method 400 can proceed to operations and decision blocks 428-444, at which the total number of points can be compared to various successively decreasing predetermined thresholds indicating corresponding levels of service until the level of service is established. The method 400 can conclude when the level of service is established and the file processing module 302 writes the level of service to a file to be sent to the ambulatory practice information system 210.

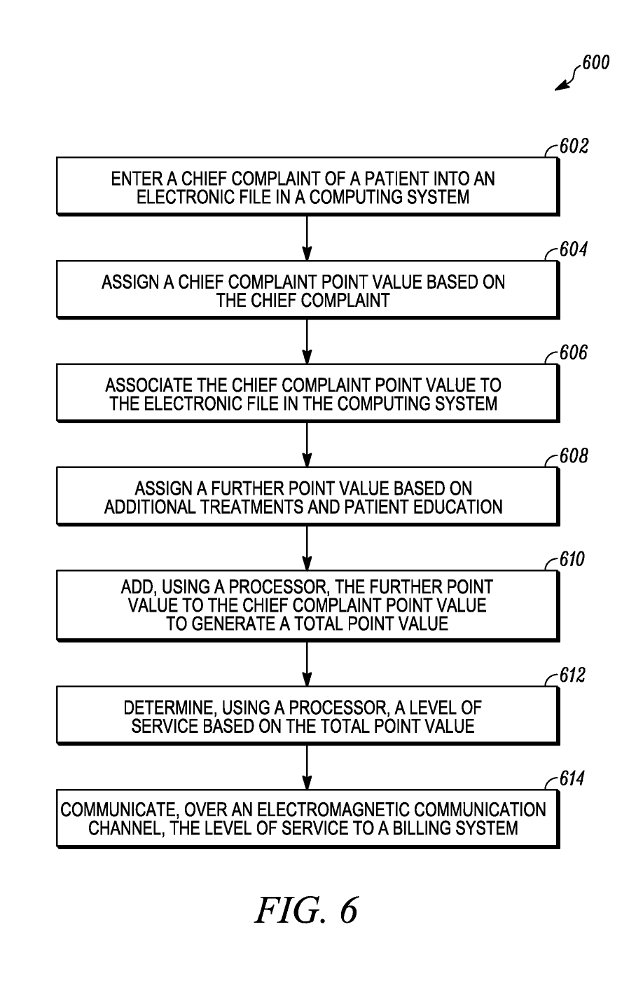

FIG. 6 illustrates a flow chart of a method 600 for tracking medical care, e.g., ambulatory or emergency department care. The method 600 can commence at operation 602 with the file processing module entering a chief complaint of a patient into an electronic file in a computing system such as the ambulatory practice information system 210. For example, a nurse can select a chief complaint by searching through the complaint list and selecting the one that fits best. The chief complaint can be entered during the triage process. The ambulatory practice information system 210 can include a chief complaint section associated with a charges section in a user interface. The chief complaint section can make it easier for the medical care facility personnel to verify that the chief compliant is still applicable.

The chief complaint can be updated once more information is available. For example, the patient's original complaint is chest pain but the patient's main problem is a cough that is causing the chest pain when the patient coughs. Upon providing the patient with a prescription and the discharge, the chief complaint needs to be changed to cough. Updating the chief complaint can ensure that the correct number of base points are pulled into the charge calculator so the patient is charged correctly.

Based on the chief complaint entered in the computing system, the point assigning module 304 can assign a chief complaint point value at operation 604. For example, when the nurse selects a chief complaint, base points corresponding charges are assigned. At operation 606, the associating module 306 can associate the chief complaint point value to the electronic file in the computing system. In some example embodiments, a chief complaint can only be selected in a preference list associated with the ambulatory practice information system 210. This would be put in place so that only the ambulatory practice 105 can have a preference list mapped to the base points.

The data can be stored to a file. Later, the processor 308 can utilize a computer program (e.g., a Perl script, C+, etc) to read the file to determine whether there is a chief complaint based on a code from the record ID field. There can be multiple chief complaints, but only the one with the most point values associated can be utilized. The chief complaints can come in any order, but only the one that has the highest number of points can be selected. According to the government mandate, special processing may need to be performed when the patient is in critical care. The government mandate can specify, for example, the number of minutes of care with the doctor.

When the patient's visit is a critical care visit, a special value can be inserted in the record. This value or a flag can indicate a possibility of a special processing when the total number of points is calculated. If, however, the patient does not require critical care, there can be multiple other items having certain associated values based on what procedures have been performed and documented. Each procedure can have associated point values. A computer program can total up these point values until the end of the file is reached.

At operation 608, the point assigning module 304 can assign a further point value based on additional treatments or patient education, if appropriate. Order management points can be added to account for the emergency resources expended to ensure that orders are noted, communicated, and followed up as needed. This can include nursing or other staff time required prior to or following the performance of the order itself. Nursing functions can include immediate referrals, transfers and admissions, for example. Order management points do not include time spent in actual performance of separately billable procedures. Lab tests can be credited only when labs are ordered. X-ray(s)/EKG(s)/and other ancillary services may be credited as needed. Other example services for which points can be assigned include CT/MRI/Ultrasound. The charges can be triggered off when the orders are written. Patient education includes education provided to the patient by the clinical staff during or at the end of a visit. Process management includes assisting a provider with an exam, consultations with social or ancillary departments, psychological consultations, one-on-one care and critical care, for example. Social or psychological crisis can require additional resources such as nursing, ancillary, or security staff.

Additional resource points can be assigned for management of a patient who meets a predetermined definition for critical care. Such patient can require that critical care service be provided for a certain period of time. For a patient in critical care, additional resource points can be given for the high intensity of facility resources required to provide such critical care services. The critical care points can be intended to provide extra points for frequent, concise, appropriate documentation in a critical situation without the code having to take time to count the notes. Additional critical care time can also be built in the charges section.

Once the charges are finalized, the charges can be completed in the user interface. The user can verify that the chief complaint is correct before submitting the charges. If he user determines that the chief complaint is not correct, the user can select a different chief complaint and make an explanation note.

At operation 610, the processor 308 can add the further point value to the chief complaint point value to generate a total point value. A computer language such as a Perl script can be utilized to process records associated with the patient, keeping its score. When it gets to the end of the file, it pulls that score, runs it through a table, and sets the level of service. To complete the charges, the medical facility personnel can select a section in the user interface enabling to capture the charges. A charge calculator can open to allow a view of the charges for the patient. If the ambulatory practice critical care has a point value, it can be included in the total number of points used to calculate the critical care charge.

At operation 612, the processor 308 can determine, based on the total point value, a level of service. The points can keep adding the values until the end is reached and then the processor 308 can calculate the total number of points. The processor 310 can add critical points to all the other points that are being added. A critical care visit can be based upon reaching a predetermined level of service. For example, the critical care visit may require reaching a level 5 visit. The following provides examples of various conditions that can be associated with certain levels. In a system utilizing levels 1-5, level 1 can correspond to a finger cut that does not require any stitches. Level 2 can correspond to a finger cut that requires stitches.

Levels 3 and 4 get more serious with significant care that needs to be performed in order to treat the patient. The severity of conditions increase until level 5 is reached. Typically, levels 1-4 cases do not belong in the ambulatory practice. Thus, for example, in order to have critical care, like trauma, level 5 status needs to be achieved.

Levels are determined based on the total number of points calculated. For example, level 5 can require the total number of points to be more than 17. The points system allows recording the resources utilized to care for a patient. Different resources can have different values. For example, a patient can come into the medical care facility speaking a language that requires an additional resource of an outside interpreter. Further, different types of practices can include varying point values for each level. At operation 614, the communication module 310 can communicate, over an electromagnetic communication channel, the level of service to a billing system.

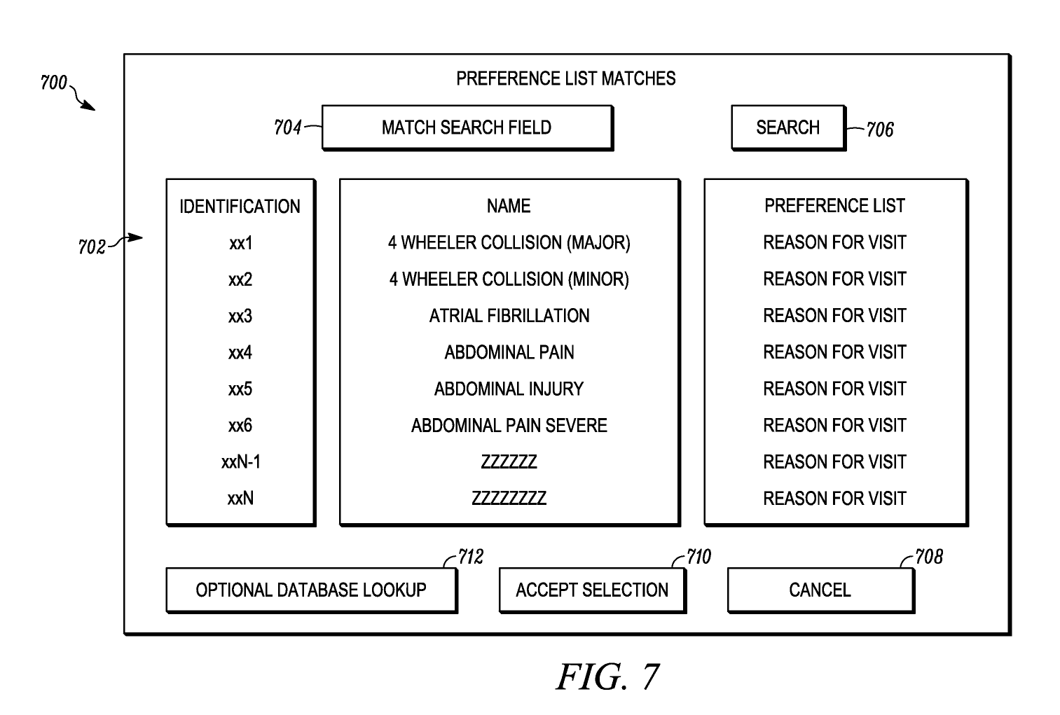

FIG. 7 illustrates an example preference list 700. The preference list 700 can be utilized to select a chief complaint. The preference list 700 can include a chief complaint row 702, a search field 704, a find button 706, a cancel button 708, an accept selection button 710, and a database lookup button 712. The preference list 700 can be included in the ambulatory practice information system 210. In some example embodiments, a user can only select the chief complaint row 702 using the ambulatory practice information system 210. The search field 704 can facilitate lookup of the chief complaint 702 by permitting a keyword insertion into the search field. Thereafter a user can push the find button 706 and wait for the results. A user can push the cancel button 708 to close the preference list 700. For example, the user can push the cancel button 708 upon determining that a suitable chief complaint is not in the preference list 700 or upon determining that entering a chief complaint is not necessary. The optional database lookup button can be used to look up additional chief complaints. The accept selection button 710 allows finalizing the selection.

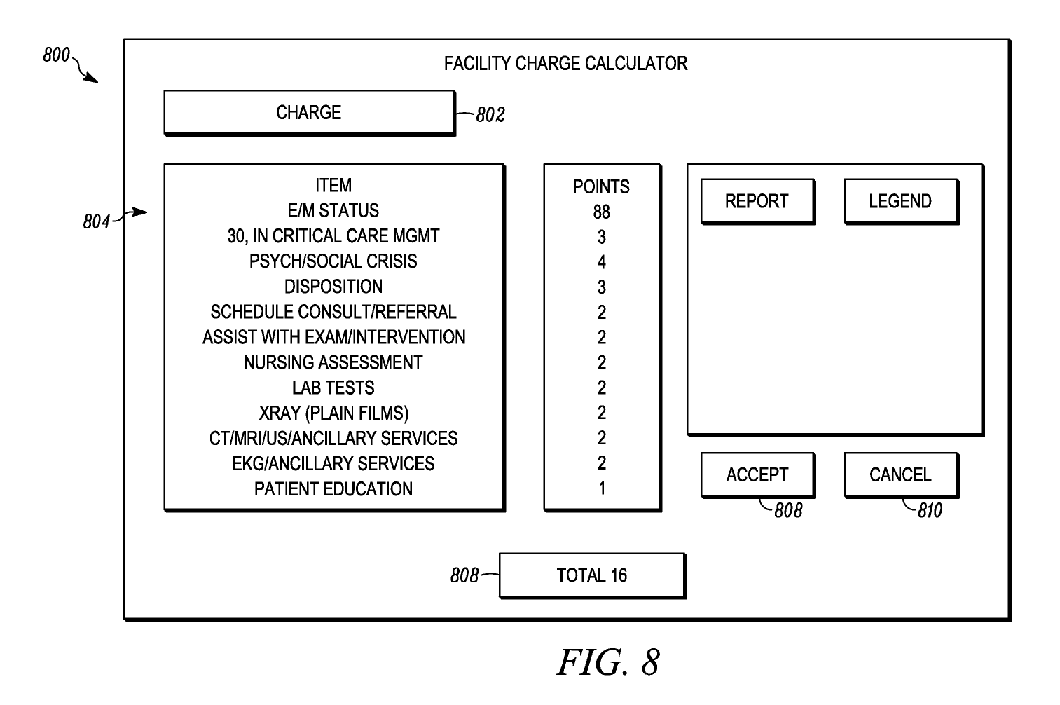

FIG. 8 illustrates a facility charge calculator 800. The facility charge calculator 800 can include a charge field 802, charge items 804, a total 806, an accept button 808, and a cancel button 810. The total 806 can be calculated by adding the total points and chief complaint points. A computer program such as Perl script can facilitate these calculations. The facility charge calculator 800 can illustrate all points going into the calculation of the total 806. A user may be able to edit points manually. Upon finalizing of the process, the user can either push the accept button 808 to accept the charges or push the cancel button 808 to cancel the facility charge calculator 800 without accepting the charges.

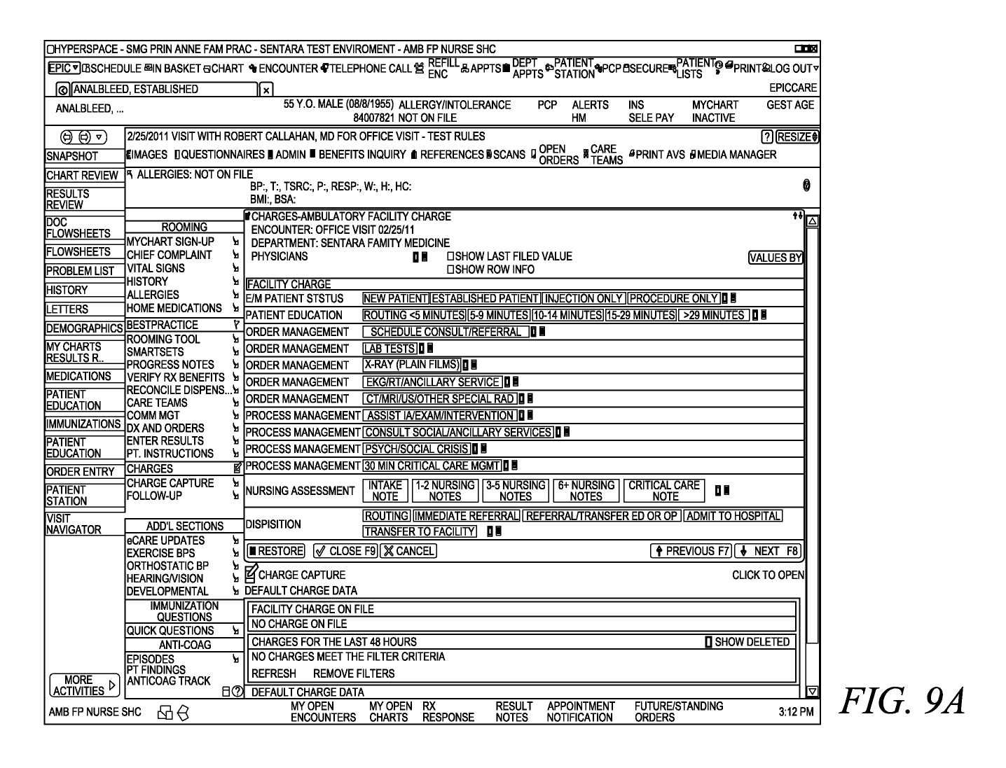

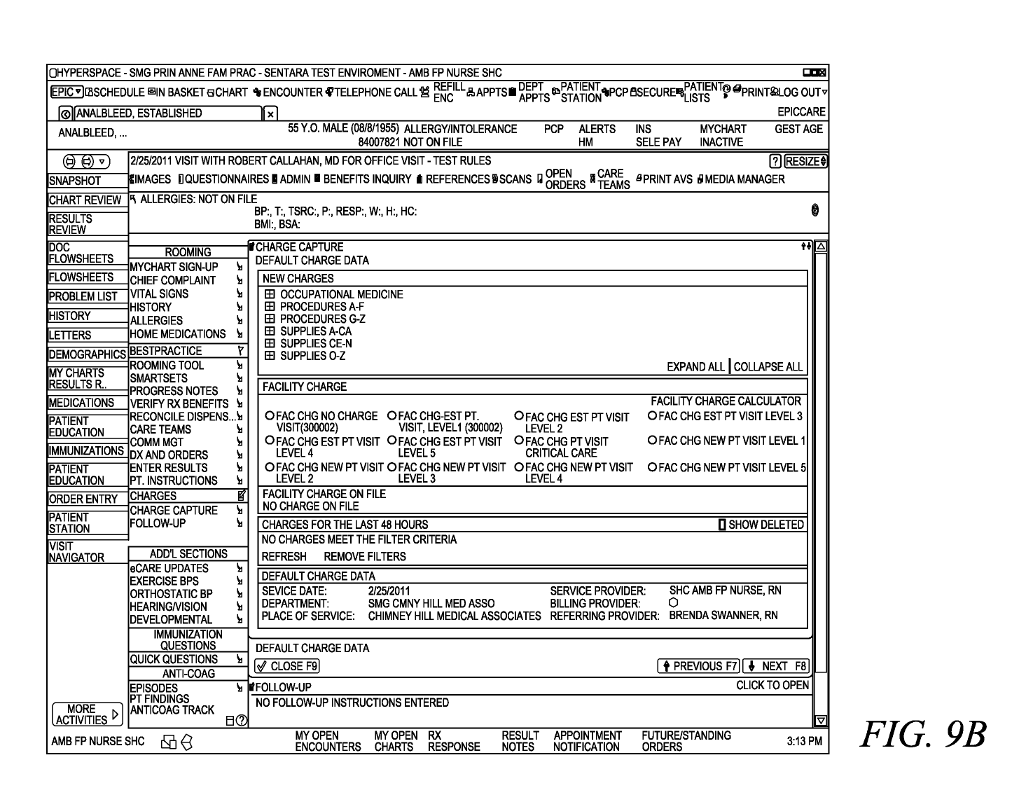

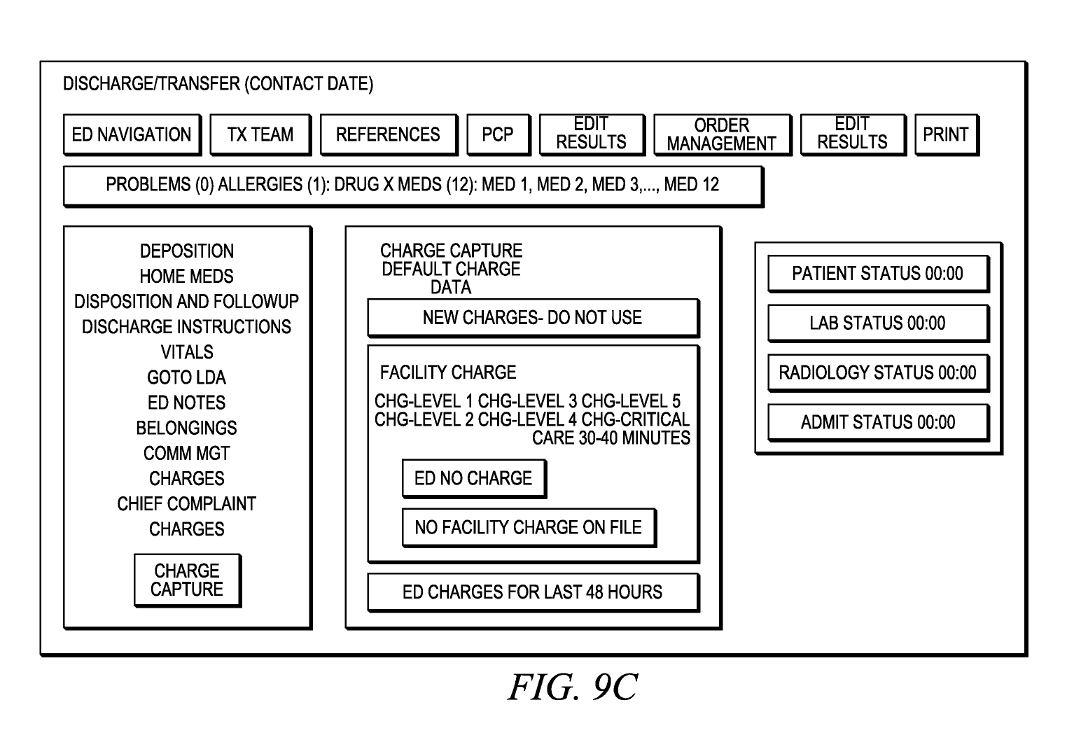

FIGS. 9A-B illustrate how, based on the captured charges, a level of service can be determined. FIGS. 9A-B show screen shots that can be generated and presented on displays when the present methods are being used.

FIG. 9C shows a screen shot for an emergency department care. Such ED care can occur before or after the ambulatory care as described herein. A central billing system or records systems can receive data from both the ambulatory system(s) and the emergency department system(s).

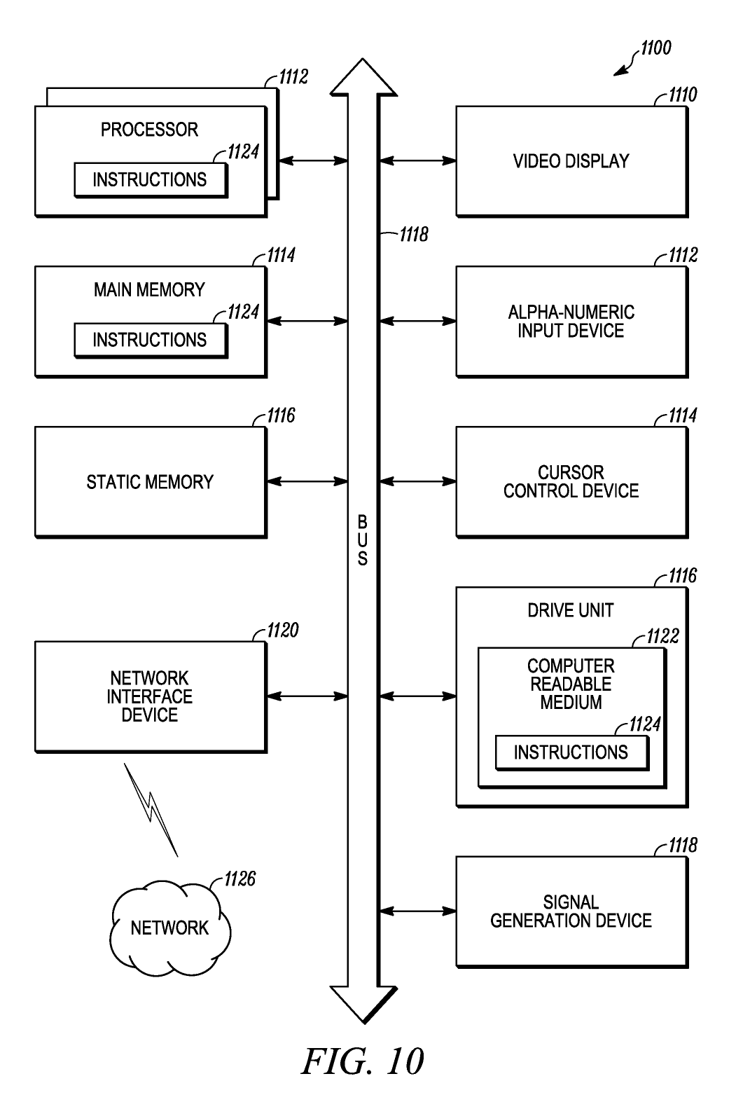

FIG. 10 shows a diagrammatic representation of machine in the example form of a computer system 1100 within which a set of instructions may be executed causing the machine to perform any one or more of the methods, processes, operations, applications, or methodologies discussed herein, for example, ambulatory medical care. The computing systems of the insurance company 107 or the catastrophe response unit 110 can each include at least one of the computer system 1100.

In an example embodiment, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a server computer, a client computer, a personal computer (PC), a tablet PC, a set-top box (STB), a Personal Digital Assistant (PDA), a cellular telephone, a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 1100 includes a processor 1102 (e.g., a central processing unit (CPU) a graphics processing unit (GPU) or both), a main memory 1104 and a static memory 1106, which communicate with each other via a bus 1110. The computer system 1100 may further include a video display unit 1110 (e.g., a liquid crystal display (LCD), plasma display, or a cathode ray tube (CRT)). The computer system 1100 also includes an alphanumeric input device 1112 (e.g., a keyboard), a cursor control device 1114 (e.g., a mouse), a drive unit 1116, a signal generation device 1118 (e.g., a speaker) and a network interface device 1120.

The drive unit 1116 includes a machine-readable medium 1122 on which is stored one or more sets of instructions (e.g., software 1124) embodying any one or more of the methodologies or functions described herein. The software 1124 may also reside, completely or at least partially, within the main memory 1104 and/or within the processor 1102 during execution thereof by the computer system 1100, the main memory 1104 and the processor 1102 constituting machine-readable media.

The software 1124 may further be transmitted or received over a network 1126 via the network interface device 1120. While the machine-readable medium 1122 is shown in an example embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that cause the machine to perform any one or more of the methodologies shown in the various embodiments of the present invention. The term “machine-readable medium” shall accordingly be taken to include, but not be limited to, solid-state memories and optical and magnetic media, and physical carrier constructs.

Certain systems, apparatus, applications or processes are described herein as including a number of modules or mechanisms. A module or a mechanism can be a unit of distinct functionality that can provide information to, and receive information from, other modules. Accordingly, the described modules may be regarded as being communicatively coupled. Modules may also initiate communication with input or output devices, and can operate on a resource (e.g., a collection of information). The modules be implemented as hardware circuitry, optical components, single or multi-processor circuits, memory circuits, software program modules and objects, firmware, and combinations thereof, as appropriate for particular implementations of various embodiments.

Aspects of the embodiments are operational with numerous other general purpose or special purpose computing environments or configurations can be used for a computing system. Examples of well known computing systems, environments, and/or configurations that may be suitable for use with the embodiments include, but are not limited to, personal computers, server computers, hand-held or laptop devices, multiprocessor systems, microprocessor-based systems, set top boxes, programmable consumer electronics, network PCs, minicomputers, mainframe computers, distributed computing environments that include any of the above systems or devices, and the like.

The communication systems and devices as described herein can be used with various communication standards to connect. Examples include the Internet, but can be any network capable of communicating data between systems. other communication standards include a local intranet, a PAN (Personal Area Network), a LAN (Local Area Network), a WAN (Wide Area Network), a MAN (Metropolitan Area Network), a virtual private network (VPN), a storage area network (SAN), a frame relay connection, an Advanced Intelligent Network (AIN) connection, a synchronous optical network (SONET) connection, a digital T1, T3, E1 or E3 line, Digital Data Service (DDS) connection, DSL (Digital Subscriber Line) connection, an Ethernet connection, an ISDN (Integrated Services Digital Network) line, a dial-up port such as a V.90, V.34 or V.34bis analog modem connection, a cable modem, an ATM (Asynchronous Transfer Mode) connection, or an FDDI (Fiber Distributed Data Interface) or CDDI (Copper Distributed Data Interface) connection. Wireless communications can occur over a variety of wireless networks, including WAP (Wireless Application Protocol), GPRS (General Packet Radio Service), GSM (Global System for Mobile Communication), CDMA (Code Division Multiple Access) or TDMA (Time Division Multiple Access), cellular phone networks, GPS (Global Positioning System), CDPD (cellular digital packet data), RIM (Research in Motion, Limited) duplex paging network, Bluetooth radio, or an IEEE 802.11-based radio frequency network. Communications network 22 may yet further include or interface with any one or more of an RS-232 serial connection, an IEEE-1394 (Firewire) connection, a Fiber Channel connection, an IrDA (infrared) port, a SCSI (Small Computer Systems Interface) connection, a USB (Universal Serial Bus) connection or other wired or wireless, digital or analog interface or connection.

Aspects of the embodiments may be implemented in the general context of computer-executable instructions, such as program modules, being executed by a computer. Generally, program modules include routines, programs, objects, components, data structures, etc. that perform particular tasks or implement particular abstract data types. Aspects of the embodiments may also be practiced in distributed computing environments where tasks are performed by remote processing devices that are linked through a communications network. In a distributed computing environment, program modules may be located in both local and remote computer storage media including memory storage devices.

Thus, methods and systems for tracking medical care have been described. Although the present invention has been described with reference to specific example embodiments, it will be evident that various modifications and changes may be made to these embodiments without departing from the broader spirit and scope of the invention. Accordingly, the specification and drawings are to be regarded in an illustrative rather than a restrictive sense.

The Abstract of the Disclosure is provided to comply with 37 C.F.R. §1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment.

What is claimed is:

1. A method for ambulatory care tracking, comprising:
entering a chief complaint of an ambulatory medical patient into an electronic file in a computing system;
applying rules in a processor to assign a chief complaint point value using the chief complaint;
using a processor, associating the chief complaint point value to the care electronic file in the computing system;
determining, using a processor, a further point value based on patient education;
using the determination, assigning, using a processor, the further point value;
adding, using a processor, the further point value to the chief complaint point value to generate a total point value;
determining, using a processor, a level of service based on the total point value; and
communicating, over an electromagnetic communication channel, the level of service to a billing system.

2. The method of claim 1, wherein entering the chief complaint includes opening an ambulatory practice electronic record in an ambulatory practice computing system and opening a main patient record in a hospital computing system.

3. The method of claim 2, wherein determining the level of service includes setting a critical care flag in the ambulatory practice electronic record.

4. The method of claim 1, wherein determining the level of service includes determining a critical care level of service based on the total point value being at least a critical care point value.

5. The method of claim 4, wherein determining the critical care level of service includes requesting a confirmation of adequate documentation for the critical care level of service.

6. The method of claim 4, wherein determining the critical care level of service triggers special processing according to predetermined procedures.

7. The method of claim 6, wherein the predetermined procedures mandated by a government.

8. A machine-readable medium comprising instructions, which when implemented by one or more processors perform the following operations:
entering a chief complaint into an electronic file in a computing system;
assigning a chief complaint point value based on the chief complaint;
associating the chief complaint point value to the electronic file in the computing system;
determining a further point value based on patient education;
using the determination, assigning the further point value;
adding, using a processor, the further point value to the chief complaint point value to generate a total point value;
determining, using a processor, a level of service using the total point value; and
communicating, over an electromagnetic communication channel, the level of service to a billing system.

9. The machine-readable medium of claim 8, wherein entering the chief complaint includes opening an ambulatory practice electronic record in an ambulatory practice computing system and opening a main patient record in a hospital computing system.

10. The machine-readable medium of claim 9, wherein determining the level of service includes setting a critical care flag in the ambulatory practice electronic record.

11. The machine-readable medium of claim 8, wherein determining the level of service includes determining a critical care level of service using the total point value being at least a critical care point value.

12. The machine-readable medium of claim 11, wherein determining the critical care level of service includes requesting a confirmation of adequate documentation for the critical care level of service.

13. The machine-readable medium of claim 11, wherein determining the critical care level of service triggers special processing according to predetermined procedures.

14. The machine-readable medium of claim 13, wherein the special processing is mandated by a government.

15. A system comprising:
a subsystem that enters a chief complaint into an electronic file in a computing system;
a subsystem that assigns a chief complaint point value using the chief complaint;
a subsystem that associates the chief complaint point value to the electronic file in the computing system;
a subsystem that determines a further point value using patient education;
a subsystem that assigns the further point value using the determination;
a subsystem that adds, using a processor, the further point value to the chief complaint point value to generate a total point value;
a subsystem that determines, using a processor, a level of service using the total point value; and
a subsystem that communicates, over an electromagnetic communication channel, the level of service to a billing system.

16. The system of claim 15, wherein the subsystem entering the chief complaint is to open an ambulatory practice electronic record in an ambulatory practice computing system and opens a main patient record in a hospital computing system.

17. The system of claim 16, wherein the subsystem determining the level of service is to set a critical care flag in the ambulatory practice electronic record.

18. The system of claim 16, wherein the subsystem determining the level of service is to determine a critical care level of service using the total point value being at least a critical care point value.

19. The system of claim 18, wherein the subsystem determining the critical care level of service is to request a confirmation of adequate documentation for the critical care level of service.

20. The system of claim 18, wherein the subsystem determining the critical care level of service is to trigger special processing according to predetermined procedures.
